(19) United States
(12) Patent Application Publication
(10) Pub. No.: US 2009/0246461 A1
(43) Pub. Date: Oct. 1, 2009

(54) ARTICLE, ASSEMBLY AND PROCESS FOR PRODUCING A WATERPROOF, DEGRADATION RESISTANT AND INCREASED STRUCTURAL SUPPORTED STIFFENER INSERT SUCH AS INCORPORATED INTO A COMPOSITE PALLET CONSTRUCTION

(75) Inventor: Miguel A. Linares, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(73) Assignee: Oria Collapsibles, LLC, Auburn Hills, MI (US)

(21) Appl. No.: 12/467,601

(22) Filed: May 18, 2009

Related U.S. Application Data
(63) Continuation-in-part of application No. 12/414,017, filed on Mar. 30, 2009.
(60) Provisional application No. 61/074,306, filed on Jun. 20, 2008.
(60) Provisional application No. 61/040,228, filed on Mar. 28, 2008.

(51) Int. Cl. B32B 3/10; B65D 90/06

(52) U.S. Cl. 428/138; 156/69; 427/427.4; 427/430.1; 428/172; 428/162

(57) ABSTRACT

A structurally supporting insert and associated process including a body having a specified shape and size and including both an exterior and an interior. A first material, such as a waterproofing and/or degradation preventing spray or coating applied to each of exterior and interior locations of the body. A second material, such a composite plastic material, is applied over the first material according to a built-up thickness about the exterior of the body in order to encapsulate the body.

### CROSS-REFERENCE TO RELATED APPLICATIONS

This Application claims the benefit of U.S. Provisional Application 61/074,306 filed on Jun. 20, 2008, and is a continuation-in-part of pending U.S. patent application Ser. No. 12/414,017, filed Mar. 30, 2009, which claims the benefit of U.S. Provisional Application 61/040,228 filed Mar. 28, 2008, now abandoned.

### FIELD OF THE INVENTION

The present invention relates generally to articles, assemblies and processes for creating a reinforced article. More specifically, the present invention discloses a variety of assemblies and processes for creating a heavy duty pallet or other suitable wall, floor, container or other supporting article, such as incorporating a cardboard or other heavy duty paperboard insert which is pre-treated or coated to address either or both environmental degradation or weight supporting factors, and over which is spay or immersion applied a durable plastic coating such as including a two part resin and hardener.

### BACKGROUND OF THE INVENTION

Transport and support pallet assemblies are known in the relevant art and which are provided for supporting varying sized loads during storage or transport. Such pallet assemblies can include such as wooden or plastic construction and can further exhibit multi-piece construction.

### SUMMARY OF THE INVENTION

The present invention teaches a structurally supported insert having a body, such as for use as a load supporting pallet with a specified, typically planar, shape and which is constructed to include both an exterior and an interior. A first, typically sealant, material is applied to each of the exterior and interior of said body and typically includes any of a waterproof/sealant or a degradation resistant composition. A second material is subsequently applied over the first material, such as at least its exterior, and includes such as a composite plastic construction applied according to a built-up thickness in order to encapsulate the body.

The body may further include a corrugated paperboard material exhibiting a ribbed interior defining a plurality of interstitial spaces. A paper covering can be applied over the body, and which can also be treated and prior to application of the second material.

One variant of pallet can also include a multi piece construction with a planar shaped base, about a perimeter of which are assembled a plurality of side and end defined caps. The first and second materials are each applied according to any one of a spray, powder or fluid immersion application. Either first and/or the second materials may alternately include any of a a urethane, varnish, lacquer, latex, coat-able metal or other sealing/coating composition which provides the desired structural and/or environmental profile to the article.

Other features include the composite material incorporating a two part resin and hardener, and which can further be of either a heat thermosetting material or a thermoplastic material. Additional features include an aggregate material entrained within such as a second (plasticized) material.

In the instance of a pallet style construction, the body can exhibit forklift tine receiving apertures, these defined along each of its sides. An upper surface of the body can exhibit a first plurality of perimeter extending portions (such as extending recess pockets). An underside surface of a second identically constructed body can further exhibit a second plurality of perimeter extending and mating sized portions (such as underside projecting and elongated tabs) and which are engageable with the first plurality of recessed pockets in order to stack the pallet bodies one atop the other.

A corresponding process is also disclosed for producing a structurally supported insert and includes the steps of providing a body configured to exhibit an exterior and an interior, applying a sealant material to each of body exterior and interior, and applying a structural supporting material at least around the exterior and according to a built-up thickness. Additional steps include assembling the body from a planar shaped base and a plurality of side and end attachable caps, this occurring either prior or subsequent to application of the first sealant material. The side/end caps can be configuring with receiving apertures in order to function as a pallet.

Such a pallet style construction can again be configured to include a first plurality of perimeter extending portions along an upper surface of the body, a second plurality of perimeter engaging portions being configured along an underside surface of a second identically constructed body and which are engageable with the first plurality of portions in order to stack the bodies one atop the other.

Other steps include configuring the body to exhibit a ribbed interior defining a plurality of interstitial spaces, as well as applying a paperboard covering over the body prior to application of the structural supporting (second) material. Yet additional process steps include an alternate body construction including the provision of a corrugated material with first and second outer plies, as well as a ribbed center ply, applying the first sealant to surfaces of each of the outer and ribbed center plies, and assembling the outer plies in sandwiching fashion about the center ply prior to application of the structural supporting material. A related and downstream process step also envisions producing an insert template from a three piece assembly insert, from which is sectioned a subset portion exhibiting a pre-finished exposed edge profile.

### BRIEF DESCRIPTION OF THE DRAWINGS

Reference will now be made to the attached drawings, when read in combination with the following detailed description, wherein like reference numerals referred to like parts throughout the several views, and in which:

FIG. 1 is a multi step assembly protocol for pre-sealing, assembling and over coating a multi-piece stiffener insert according to a first preferred embodiment of the present inventions;

FIG. 2 is a related protocol to that shown in FIG. 1 and illustrating pre-treatment of an initially assembled multi-piece insert, following which occurs subsequent disassembly and exterior spray application of a over coating material;

FIG. 3 is a multi-step assembly protocol according to a Her embodiment and illustrating an optionally pre-treated insert immersion coated within a reservoir filled with such as a composite plastic or similar material;

FIG. 4 is an insert treatment and assembly protocol similar to that shown in FIG. 2 and further referencing the ability to apply a non-plasticized (e.g. urethane, varnish, lacquer, latex or other suitable waterproof and/or degradation resistant) material to the insert;

FIG. 5 is an illustration similar to that shown in FIG. 3 and in which the stiffener insert is immersed in a reservoir filled with a non-plasticized over coating material;

FIG. 6 is a multi-step protocol assembly similar to the sub-variants previously shown in FIGS. 1 and 4 and illustrating a metallic spray applied to an assembled exterior of the insert stiffener;

FIG. 7 is an illustration of a sub-assembly process illustrating each of three plies of corrugated cardboard material exhibiting a pre-treatment spray coating prior to assembly, and in order to create a rigid supporting and degradation resistant corrugated stiffener insert template from which subset sized insert portions can be sectioned without revealing untreated exposed edges;

FIG. 7A is a perspective illustration showing a stiffener insert template created by the assembly process of FIG. 7 and from which is sectioned a subset portion exhibits a pre-finished exposed edge profile;

FIG. 8 is an illustration of a three ply stiffener insert exhibiting a slightly modified cross sectional configuration in comparison to that shown in FIG. 7;

FIG. 9 is an illustration of a three ply stiffener insert according to a further modified cross sectional configuration;

FIG. 10 is a perspective illustration of an assembled and coated pallet article according to one non-limiting embodiment of the invention;

FIG. 11 is an enlarged partial view of a corner of the pallet article referenced in FIG. 10 and in which the over-coated material is removed to illustrate the pre-treated and honeycombed nature of the underlying stiffener insert;

FIG. 12 is top view of the partial corner shown in FIG. 11 and further illustrating the cutaway removal of an associated paperboard covering associated with the insert in order to reveal an inner-most structural supporting and cross-ribbing pattern; and

FIGS. 13A-13K illustrate a succession of top views depicting alternate stiffener insert patterns in use with the various assemblies and processes of the present inventions.

### DETAILED DESCRIPTION OF THE PREFERRED EMBODIMENTS

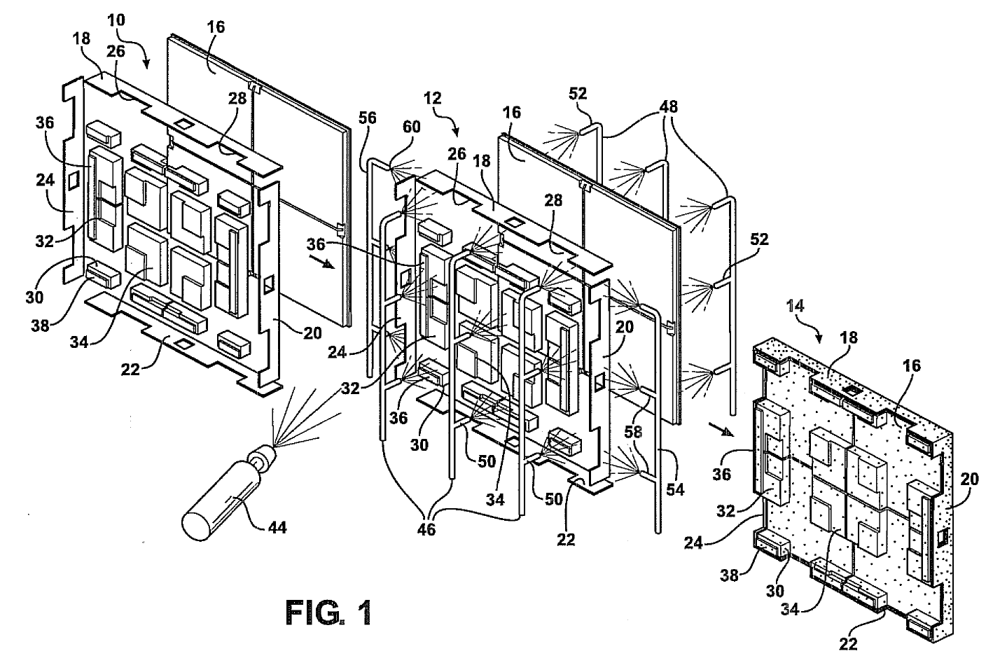

Referring to FIG. 1, a first illustration is shown of a generally multi step assembly protocol for pre-sealing, assembling and over coating a multi-piece stiffener insert according to a first preferred embodiment of the present invention. As previously described, the present invention disclose an article, assembly and associated process for producing a structurally supported template, such as for use as a load supporting pallet among other potential structural applications.

As will be described in reference to the following illustrations, the present inventions further teach and disclose a variety of differently configured and structurally supporting insert materials, each of which can exhibit a unique shape and profile, and which further exhibit both exterior facing and interior defined surfaces. A feature of the invention is the ability to pre-apply a sealant material (drawn from a variety of materials in spray, powder or immersion gaseous/fluidic form), such material not limited to a fluid sealant and/or degradation resistant application, such sealant material being pre-applied to both the exterior and interior surfaces of the body, and which is followed by the application of a second build-up coating of material (in one further example a composite plastic material) which imparts a desired degree of structural support to the body.

Referring again to FIG. 1, a series of successive assembly steps are generally shown at 10, 12 and 14 for disassembling, pre-treating/sealing, assembling and over-coating such as a pallet style article. As illustrated in initial disassembled condition 10, the insert material, and which can include without limitation a corrugated or other form of rigid paperboard material, can include a generally planar shaped base 16, about a perimeter of which are assembled a plurality of interconnected side defined caps 18, 20, 22 and 24.

As further shown, each of the edge secured caps 18-24 can exhibit underside configured apertures (see at 26 and 28 associated with indicated cap 18) these functioning as forklift tine receiving apertures. Also shown in exploded fashion are additional structural components, see as selectively referenced at 30, 32, and 34, and which are considered to be generally part of the base 16 and are secured to underside locations of the base (such as utilizing any type of mechanical or chemical fastener) and as generally referenced at final assembly step 16.

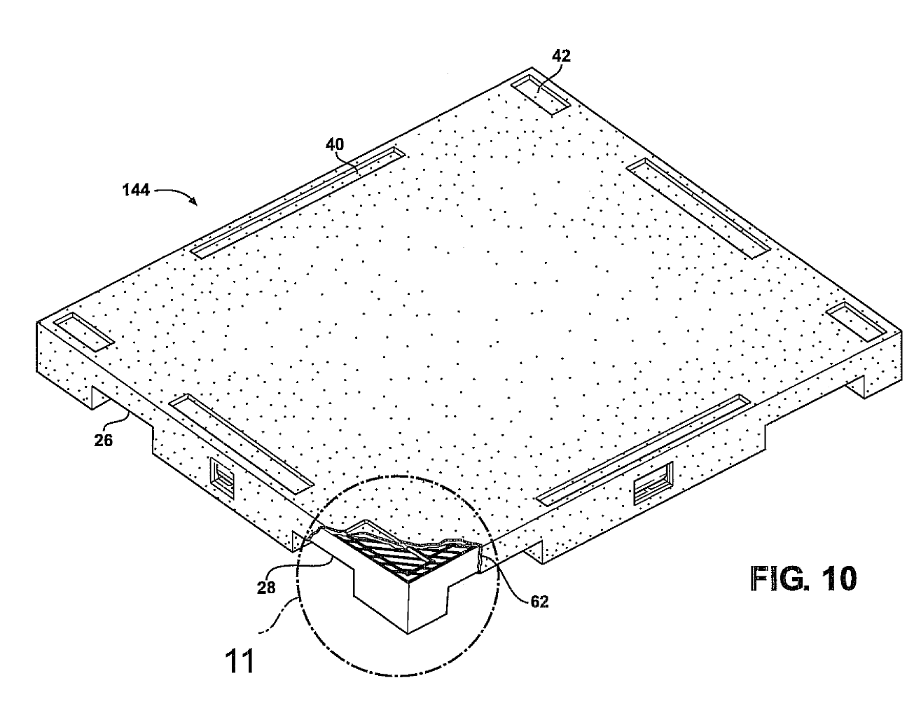

Each of underside/outer perimeter proximate located components (see for example referenced components 30 and 32) includes a perimeter extending portions (see further underside tab projections 36 and 38). Hidden from view in FIG. 1, but generally shown at 40 and 42 in the top side perspective of FIG. 10, are mating and upper surface recesses 40 and 42, these being defined in likewise generally perimeter extending fashion and which permit a second identically configured body to be stacked (via its matching pattern of underside projecting tabs 36 and 38 relative to the recessed pockets 40 and 42 located within the upper surface of the base 16) upon a first such body. The ability to securely stack a plurality of unused pallet (or other constructed) articles is desirous for purposes of minimizing storage space and the like.

Following initial disassembly at step 10, each of the surfaces (both inner and outer) of each individual piece or component is pre-treated with a first material. This can again include any of a gas, fluidic spray, and/or other particulate/fluidic application of an initial material such as again in order to provide some degree of waterproof and/or degradation impedance to the inner and outer surfaces of the rigid corrugated paperboard construction. An aerosol canister is referenced at 44 and can constitute one of many potential mediums in which the initial sealant material is provided and applied to the previously disassembled components of the insert article.

As further shown at step 12, opposing pluralities of elongated spray conduits, see at 46 and 48, are provided, each further exhibiting a pattern or array of spaced apart application nozzles, see as respectively shown at 50 and 52. As further shown, end disposed conduits 54 and 56 likewise include additional spray nozzles 58 and 60, respectively this in order to evenly apply either an initial or follow up sealant or coating to the individual pallet components. Without limitation, it is further envisioned and understood that the spray conduits and nozzles illustrated in step 12 can apply either or both the sealant undercoat and a subsequent built-up overcoat in successive fashion.

Finally, at step 14, the pallet article is illustrated in a generally and permanently assembly configuration, and in which the structurally supported and interiorly hollowed insert has been pre-coated on both its interior and exterior surfaces, this prior to the application of the second overcoat of material, see as generally represented by the coated stippling pattern as well as specifically identified in cutaway at 62 in each of FIGS. 10-12. Without limitation, the overcoat material (as well as possibly the undercoating sealant material in one or more possible sub-applications) can be applied to any thickness (such as ranging anywhere in a range of a fraction of an inch up to several inches or more further dependent upon the relative size of the insert). The second material can further include any of a composite plasticized material (this including any one or more of a thermoplastic, heat cured thermoset, or other related two part resin and hardener based composite plastic), as well as also potentially including a urethane, varnish, lacquer, latex or other material exhibiting the desired properties for a given structural/environmental application.

The assembled pallet article, again at 14, provides enhanced structural supporting (i.e. enhanced load bearing) characteristics due to the desired build-up thickness of the secondary plasticized (or other) material. Additionally, and by virtue of the interior and initial exterior surfaces of the insert body having been pre-coated with a sealant type material, the corrugated paperboard construction of the insert is protected from the effects brought on by the inevitable seepage of water or other fluidic and/or solid contaminants, such further potentially occurring as a result of surface damage to the pallet and by which the ability to retard degradation of the insert serves to maintain the ongoing usefulness of the structural article created.

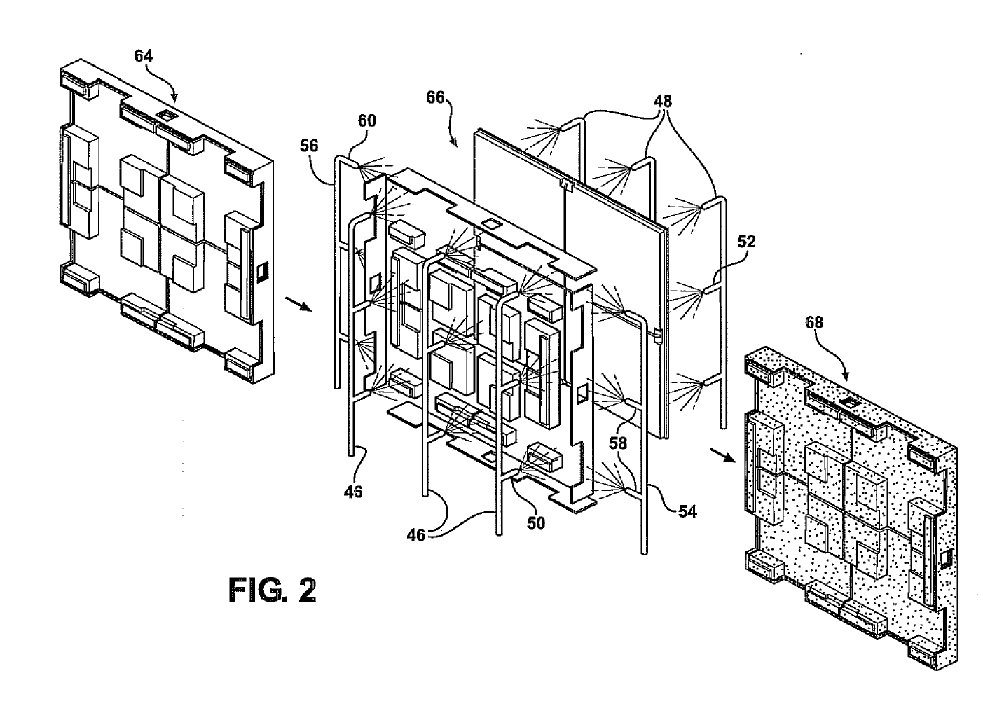

With reference to each of assembly and coating protocols set forth in each of FIGS. 2-6, a similar pallet style article is shown such that a repetitive description of its features is not necessary and is not provided for purposes of ease of illustration. Referring to FIG. 2, a related protocol to that shown in FIG. 1 illustrates a pre-treatment step of an initially assembled (either singular or multi-piece) insert and as generally shown at 64 (see also pre-treatment aerosol application 44 in FIG. 1). Following this, at step 66, occurs subsequent disassembly and exterior spray application of either or both an initial or secondary sealant as well as application of the built-up over coating material and following which, at step 68, a finished article is again provided exhibiting a built up composite (or other) material construction upon its exterior.

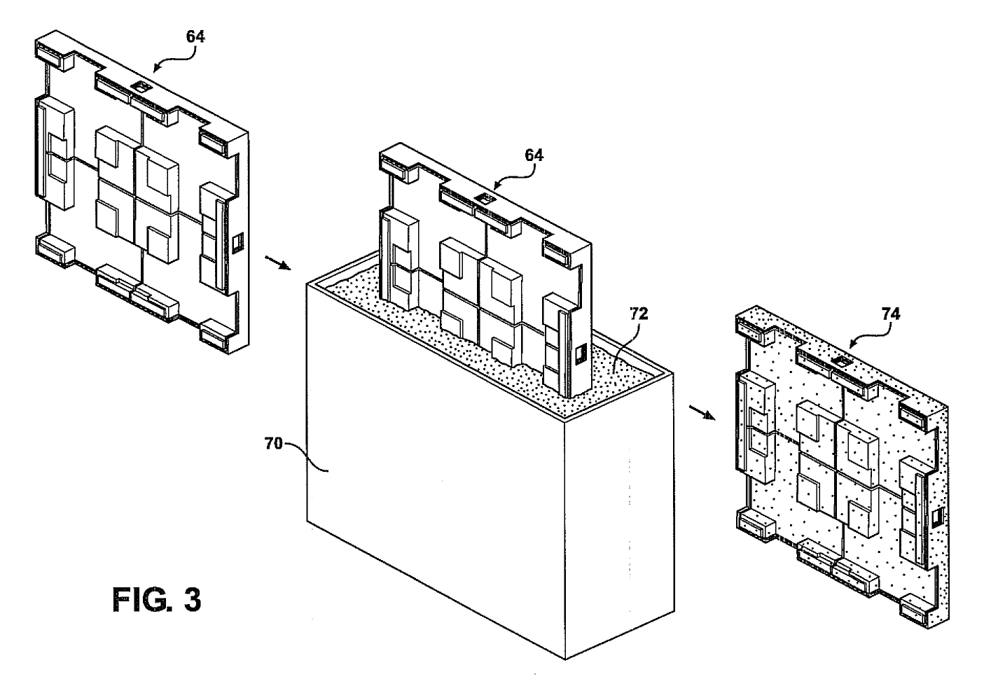

FIG. 3 illustrates a multi-step assembly protocol according to a further embodiment of an optionally pre-treated insert, see again at 64, which is subsequently immersion coated within a reservoir 70 filled with such as a composite plastic or similar material 72, again not limited to any of those previously described. The ability to immerse the insert 64 for any specified period of time within the polymeric (or other) bath material can further result in the build-up adherence of any desired thickness of second (over) coating material for a given structural supporting or other desired application and which results in a finished end product 74.

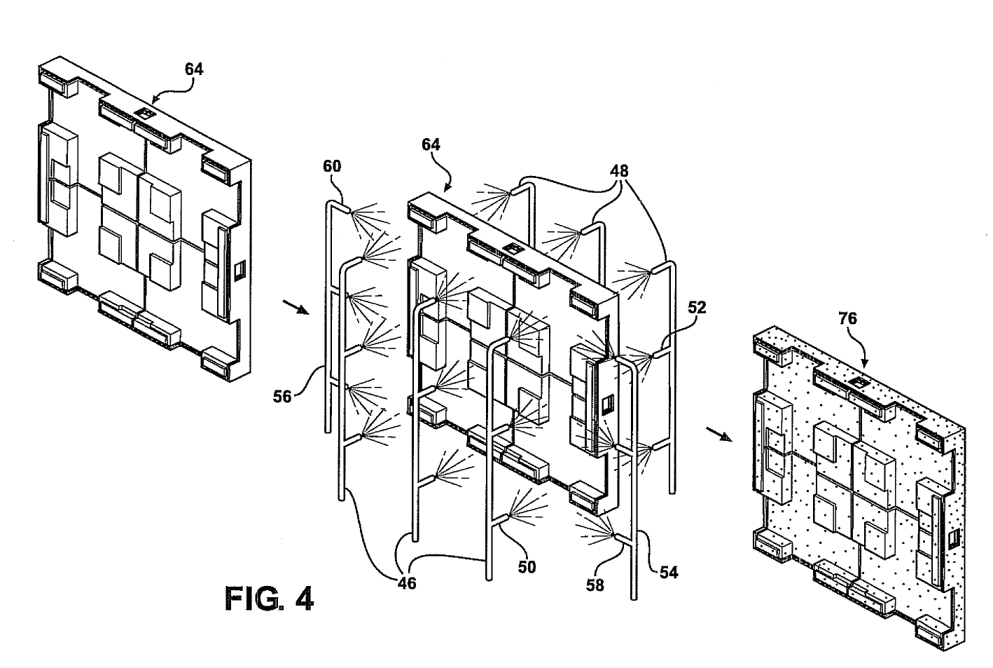

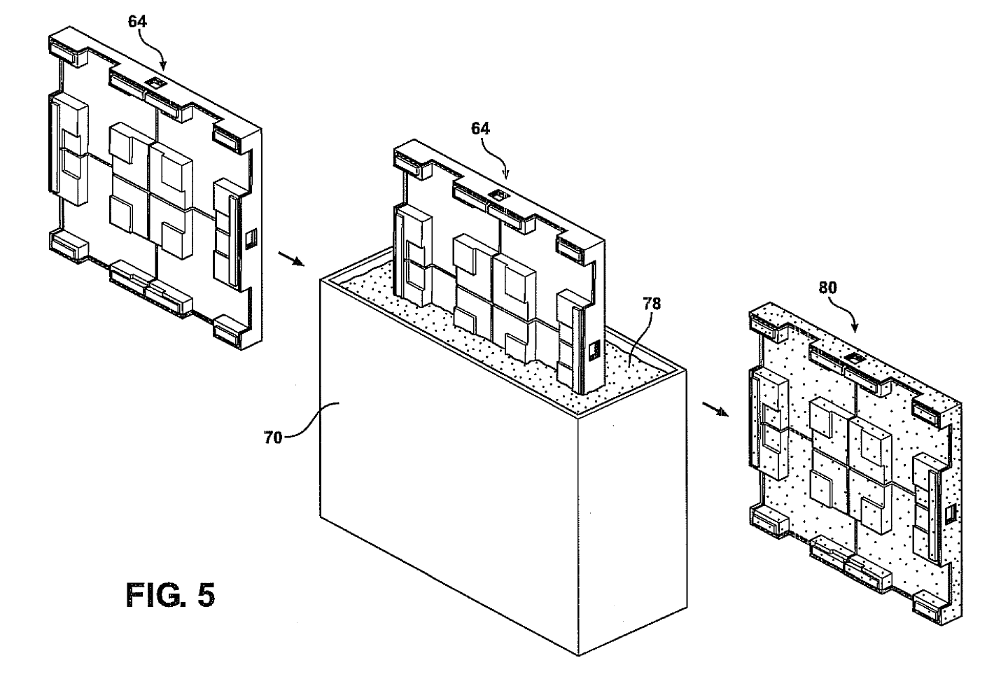

FIG. 4 is an insert treatment and assembly protocol similar to that shown in FIG. 2 and further referencing the ability to apply, via the spray arrangement previously described, a non-plasticized (e.g. urethane, varnish, lacquer, latex or other suitable waterproof and/or degradation resistant) material to the insert 64 and in order to create a finished product 76 exhibiting different material composition and resulting structural/environmental resistant properties. FIG. 5 is an illustration similar to that shown in FIG. 3 and in which the stiffener insert 64 is immersed in the reservoir 70, in this instance filed with a non-plasticized over coating material 78 such as again including any of a urethane, varnish, lacquer, latex or the like. As described in FIG. 3, an immersion period corresponds to a desired build-up thickness of the eventual insert article 80 and which exhibits a desired set of properties for a given application.

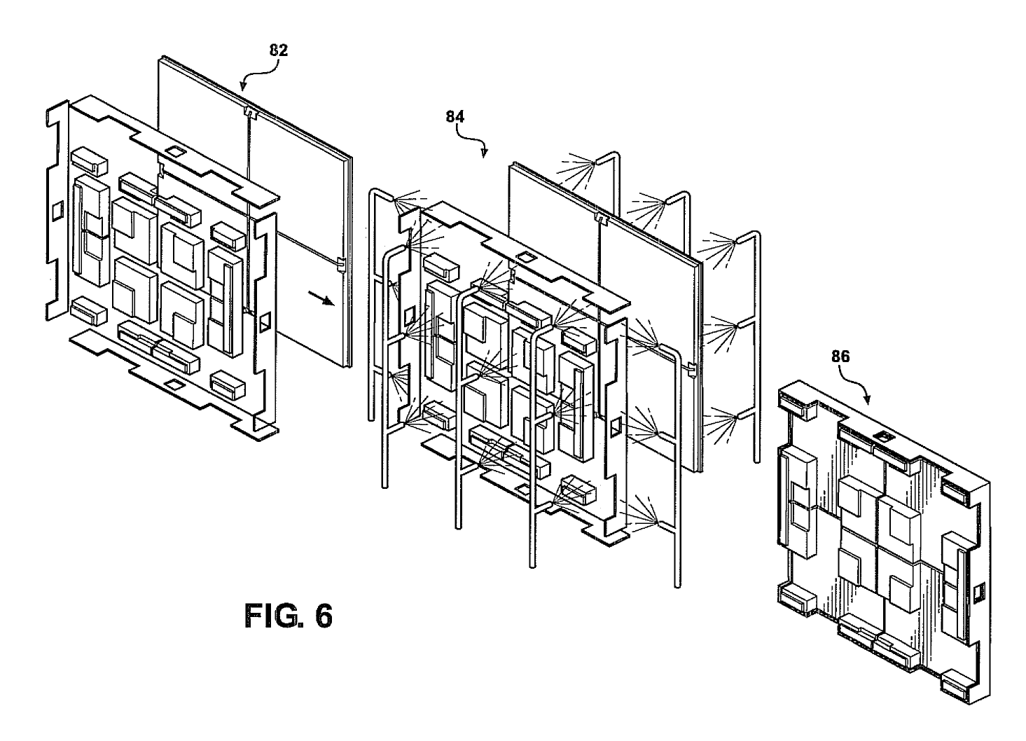

FIG. 6 is a multi-step protocol, see steps 82, 84 and 86, similar to the sub-variants previously shown in FIGS. 1 and 4 and illustrates an alternative metallic spray applied by the nozzle arrangement previously identified (again at 84), this occurring following an initial pre-sealant applied to interior/exterior surfaces of the previously disassembled components. As also described previously, the metal spray (such as without limitation an aluminum or chrome based spray) can correspond to a second coated material and can be applied either prior or subsequent to re-assembly of the insert components and, upon drying, to provide the insert with a desired exterior profile 86 according to any thickness.

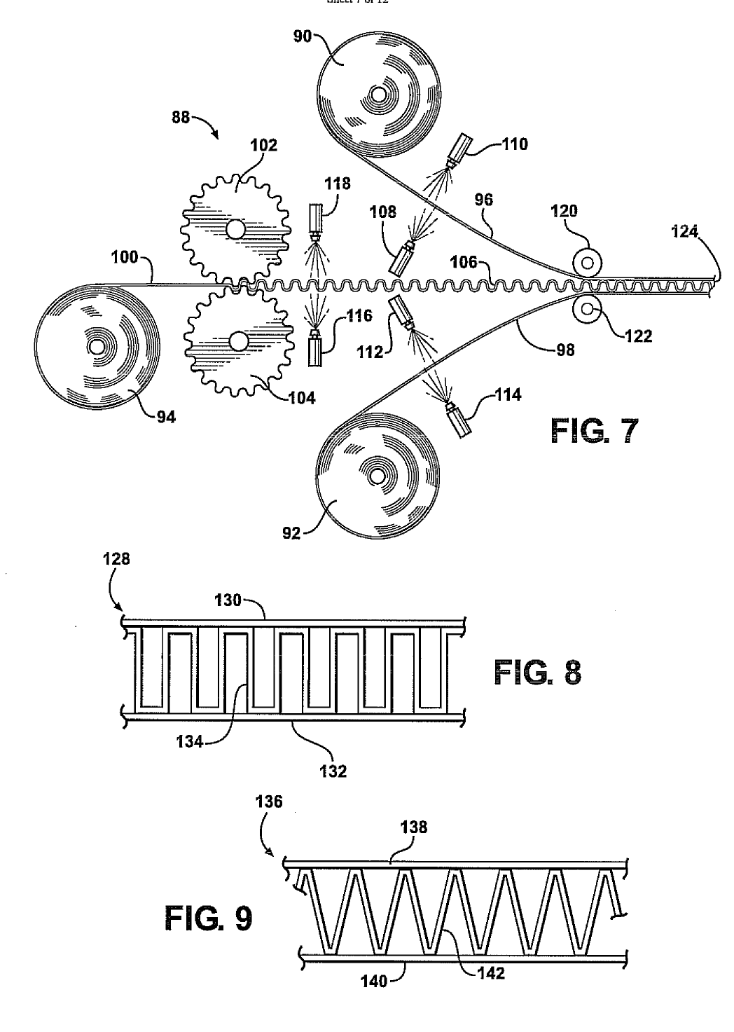

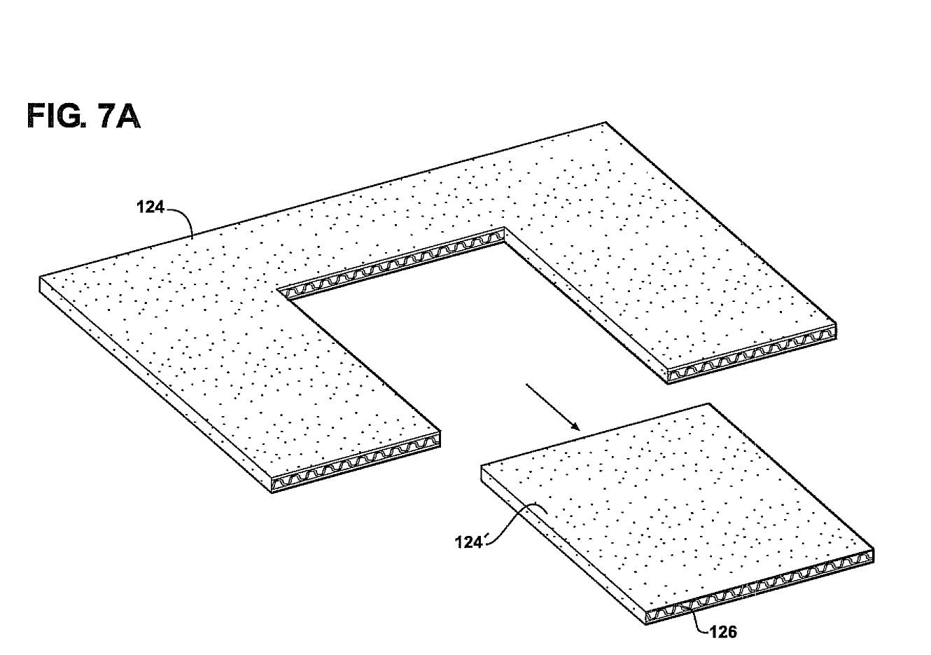

Referring to FIG. 7, an illustration is generally shown at 88 of a sub-assembly process for producing a pre-coated and three piece (or ply) template material according to a further desired embodiment. The insert article produced according to this embodiment differs from that generally referenced in the previous illustrations of FIGS. 1-6, and can be utilized in any one of a number of varied applications not limited to a pallet construction.

A plurality of three elongated rolls of paperboard material are provided at 90, 92 and 94, each unwinding a designated ply or layer of material, this correspondingly referenced by outer plies 96 and 98 and center ply 100. The center ply 100 is deformed along its cross section, via a pair of opposing and intermeshing surface deformation rollers 102 and 104, and in order to exhibit a ribbed three dimensional profile, further referenced at 106.

Further illustrated are sets of opposing arrayed spray nozzles, see as shown at 108 & 110, 112 & 114, and 116 & 118, these corresponding to the outer plies 96 and 98 and center ribbed ply 106 are respective sets of opposing arrayed spray nozzles, these applying the initial sealant material according to any of those previously described. Following pre-treatment of both upper and lower surfaces of each ply 96, 98 and 100 (as further ribbed at 106) is assembled, see further rollers 120 and 122, in a sandwiched fashion and in order to exhibit a desired configuration (at 124).

The pre-treatment spray coating of the individual plies 96, 98 and 100, prior to assembly by final assembly rollers 120 and 122, creates a rigid supporting and degradation resistant corrugated stiffener insert template 124, such as is again shown in the three dimensional perspective of FIG. 7A. From this template, a subset sized insert portion, see as further shown at 124′, can be sectioned without revealing untreated exposed edges which may otherwise require additional finishing steps. Reference is made to pre-finished exposed edge profile 126 associated with the cutout portion 124′ and which can be immediately post-processed such as through the application of a composite plastic or other suitable structurally supporting and built-up material as previously illustrated and described, this again including any of build up immersion coating, spray coating or other structural buildup applications to create a finished structurally supporting article exhibiting the desired properties.

Referring to FIG. 8, an illustration is generally shown at 128 in cross section of a three ply stiffener insert exhibiting a slightly modified cross sectional configuration in comparison to that shown at 124 in FIG. 7, and in which upper 130 and lower 132 plies sandwich about a central ribbed ply 134 which further exhibits a substantially square shaped repeating profile in contrast to the curved profile exhibited by corrugated pattern 106 in FIG. 7. FIG. 9 is an illustration of a three ply stiffener insert 136 according to a further modified cross sectional configuration and again including upper 138 and lower 140 plies sandwiching there between a central ribbed ply exhibiting a in cross section a more generally triangular shaped repeating profile.

FIG. 10 is a perspective illustration generally shown at 144 of an assembled and coated pallet article according to a further non-limiting embodiment of the invention. In particular, the insert article shown at 144 generally corresponds in structure and configuration to that previously identified in each of FIGS. 1-6 and again illustrates the features of the upper surface recess pockets 40 and 42 as well as the edge positioned forklift tine receiving apertures 26 and 28.

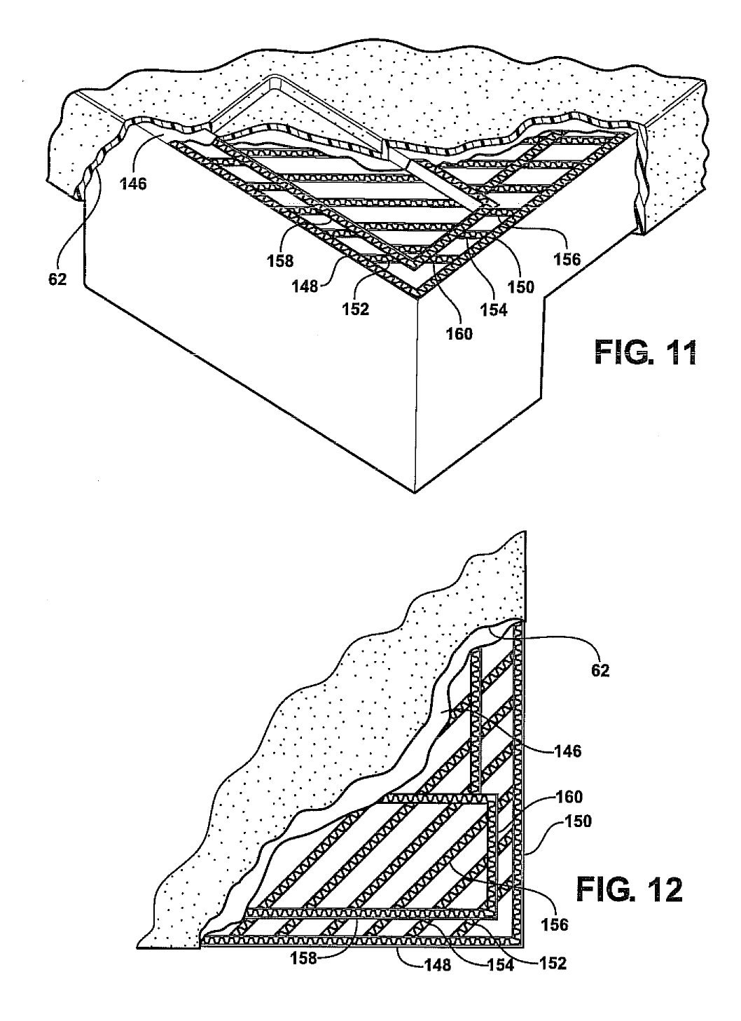

As further illustrated in each of the enlarged partial view in cutaway (FIG. 11) and the top plan view (FIG. 12), a selected corner portion of the pallet article referenced in FIG. 10 is again shown and in which the over-coated material (previously shown at 62), as well as an intermediate sandwiching paperboard covering material 146 (see both FIGS. 11 and 12) is removed to illustrate the honeycombed nature of the underlying stiffener insert. This is further referenced by spaced apart ribbed or like interconnected portions (see selected outer perimeter portions 148 and 150, between which extend interconnecting interior ribbed portions 152, 154, 156 et seq., as well as additional and recess pocket defining portions 158, 160, et seq.), these collectively defining a specified interstitial pattern for providing the combined features of strength and material savings.

As with previously described embodiments, the inner core of the insert is pretreated according to any desired fashion (this also including an invisible coating or other pre-treatment applied using any of a spray, gaseous composition or the like), prior to subsequent overcoating with the built up composite material (e.g. again at 62) and so that the eventual structural supporting article exhibits any desired performance and environmental resistant characteristics. It is also envisioned that the intermediate paperboard covering or sheet 146 can be either removed or treated and applied following initial sealant of the ribbed interior of the pallet body and the filling of the interior with an initial volume of a settable polymeric composition, following which the separately treated covering 146 can be applied and a succeeding buildup layer (again at 62) can be applied according to any of the methods previously discussed and to produce the finished article.

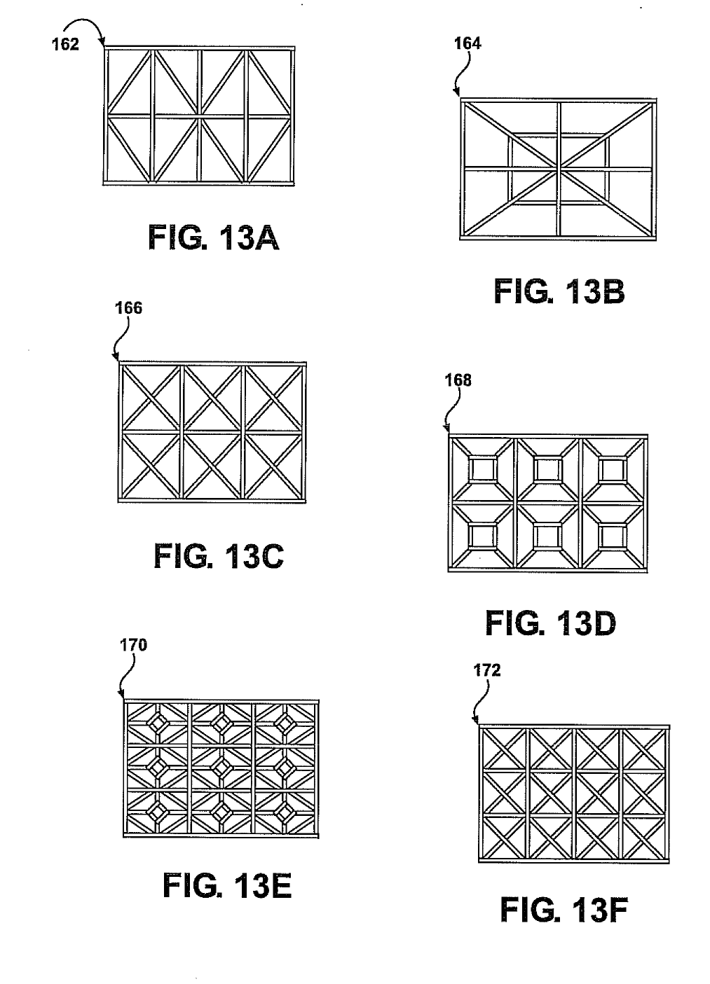

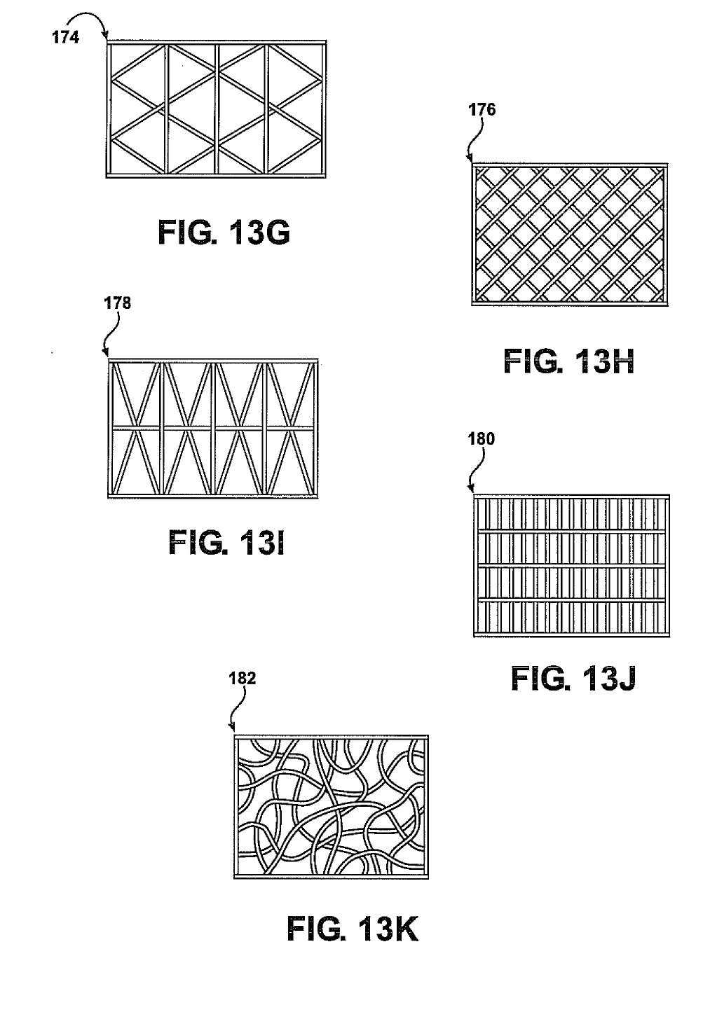

Finally, FIGS. 13A-13K each illustrate in rough schematic a succession of top views (see at 162-182) depicting alternate stiffener insert patterns in use with the various assemblies and processes of the present inventions. In each succeeding schematic illustration, a skeletal structure of a pallet or other planar article shaped profile is depicted with four outer interconnecting sides, and between which a varied arrangement of crosswise and/or angled interior ribbed supports are shown (reference again in particular made to each of the depicted patterns 162 (FIG. 13A), 164 (FIG. 13B), 166 (FIG. 13C), 168 (FIG. 13D), 170 (FIG. 13E), 172 (FIG. 13F), 174 (FIG. 13G), 176 (FIG. 13H), 178 (FIG. 13I) and 180 (FIG. 13J), each of which further including some subset varied combination of both cross and angled interior ribbed supports and, in the further instance of FIG. 13H, only inner angled ribbed supports or, in the further instance of FIG. 13J, only perpendicular cross member supports. In the final depiction of FIG. 13K, an erratic/arcuate pattern 182 is depicted and which is intended only to show that the present invention is capable of incorporating a structurally supporting insert incorporating any desired structural supporting pattern or construction such as which depicts any type of interstitial pattern existing between the varied rib configurations.

A corresponding process is also disclosed for producing a structurally supported insert and includes the steps of providing a body configured to exhibit an exterior and an interior, applying a sealant material to each of body exterior and interior, and applying a structural supporting material at least around the exterior and according to a built-up thickness. Additional steps include assembling the body from a planar shaped base and a plurality of side and end attachable caps, this occurring either prior or subsequent to application of the first sealant material. The side/end caps can be configuring with receiving apertures in order to function as a pallet.

Such a pallet style construction can again be configured to include a first plurality of perimeter extending portions along an upper surface of the body, a second plurality of perimeter engaging portions being configured along an underside surface of a second identically constructed body and which are engageable with the first plurality of portions in order to stack the bodies one atop the other.

Other steps include configuring the body to exhibit a ribbed interior defining a plurality of interstitial spaces, as well as applying a paperboard covering over the body prior to application of the structural supporting (second) material. Yet additional process steps include an alternate body construction including the provision of a corrugated material with first and second outer plies, as well as a ribbed center ply, applying the first sealant to surfaces of each of the outer and ribbed center plies, and assembling the outer plies in sandwiching fashion about the center ply prior to application of the structural supporting material. A related and downstream process step also envisions producing an insert template from a three piece assembly insert, from which is sectioned a subset portion exhibiting a pre-finished exposed edge profile.

Having described my invention, other additional preferred embodiments will become apparent to those skilled in the art to which it pertains, and without deviating from the scope of the appended claims.

I claim:

1. A structurally supported insert, comprising:
a body having a specified shape and size and including both an exterior and an interior;
a first material applied to each of said exterior and interior of said body; and
a second material applied over said first material and according to a built-up thickness about said exterior of said body in order to encapsulate said body.

2. The article as described in claim 1, said body further comprising a corrugated paperboard material exhibiting a ribbed interior defining a plurality of interstitial spaces.

3. The article as described 2, said insert further comprising a paper covering applied over said body and prior to application of said second material.

4. The article as described in claim 1, said body further comprising a planar shaped base, about a perimeter of which are assembled a plurality of interconnected side defined caps.

5. The article as described in claim 1, said first material further comprising at least one of a waterproof/sealant and a degradation resistant composition applied in any of a spray, powder or fluid immersion application.

6. The article as described in claim 1, said second material further comprising a composite plasticized material.

7. The article as described in claim 1, at least one of said first and second materials further comprising any one of a urethane, a varnish, a lacquer, a latex, and a coatable metal.

8. The article as described in claim 6, said composite material further comprising at least one of a heat/fire thermosetting and a thermoplastic material.

9. The article as described in claim 6, further comprising an aggregate material entrained within said plasticized material.

10. The article as described in claim 1, said body further comprising a pallet and exhibiting forklift tine receiving apertures defined along each of a plurality of interconnected sides.

11. The article as described in claim 1, an upper surface of said body exhibiting a first plurality of perimeter extending portions, an underside surface of a second identically constructed body exhibiting a second plurality of perimeter extending portions engageable with said first plurality of portions in order to stack said bodies one atop the other.

12. The article as described in claim 11, said first and second pluralities of engageable portions each including either of surface projecting or mating surface recessed portions.

13. A process for producing a structurally supported insert, comprising the steps of:
providing a body configured to exhibit an exterior and an interior;
applying a sealant material to each of said exterior and interior; and
applying a structural supporting material at least around said exterior and according to a built-up thickness.

14. The process according to claim 13, further comprising the step of assembling said body from a planar shaped base and a plurality of interconnecting and attachable caps either prior or subsequent to application of said sealant.

15. The process according to claim 13, further comprising the step configuring said body to exhibit a ribbed interior defining a plurality of interstitial spaces.

16. The process according to claim 15, further comprising the step of applying a paperboard covering over said body prior to application of said structural supporting material.

17. The process according to claim 13, further comprising the steps of:
providing said body with first and second outer plies and a ribbed center ply;
applying said sealant to surfaces of each of said outer and ribbed center plies; and
assembling said outer plies in sandwiching fashion about said center ply prior to application of said structural supporting material.

18. The process according to claim 17, further comprising the step of producing an insert template from which is sectioned a subset portion exhibiting a pre-finished exposed edge profile.

19. The process according to claim 13, further comprising the step of configuring said body with side and end positioned receiving apertures defined along its perimeter and in order to function as a pallet.

20. The process according to claim 13, further comprising the step of configuring a first plurality of perimeter extending portions along an upper surface of said body, a second plurality of perimeter engaging portions being configured along an underside surface of a second identically constructed body and which are engageable with said first plurality of portions in order to stack said bodies one atop the other.
